(19) United States
(12) Patent Application Publication
(10) Pub. No.: US 2013/0029275 A1
(43) Pub. Date: Jan. 31, 2013

(54) DECORATED CANDLE AND DECORATION PROCESS FOR OBTAINING THE SAME

(71) Applicant: Joao Maria Trigueiros de Sousa Alvim, Estoril (PT)

(72) Inventor: Joao Maria Trigueiros de Sousa Alvim, Estoril (PT)

(73) Assignee: ARTCANDLE - TRANSFORMACAO E COMERCIO DE VELAS, UNIPESSOAL, LDA., Estoril (PT)

(21) Appl. No.: 13/640,289

(22) PCT Filed: Nov. 25, 2010
(86) PCT No.: PCT/PT10/00049

§ 371 Date: Oct. 9, 2012

(30) Foreign Application Priority Data
Apr. 19, 2010 (PT) 105056

(51) Int. Cl. F23D 3/16; B32B 37/14; B05D 5/00

(52) U.S. Cl. 431/288; 427/265; 156/280

(57) ABSTRACT

Decorated candles and a process for obtaining the same, relate to candles having decorative patterns protected with a transparent lining. The candles exhibit a decoration similar to decoration of porcelain items, simulating porcelain candles.

### FIELD OF INVENTION

The present invention relates to decorated candles and to a decoration process thereof, and more particularly relates to candles having decorative patterns protected with a transparent lining, and to the decoration process for obtaining the same. The present invention candles exhibit a high quality decoration, such as they were porcelain candles.

### BACKGROUND OF THE INVENTION

Candle production and decoration were, since always, very creative activities, presenting very different solutions that have been developed in the actual manufacture process, both industrial and handcrafted. Thus, the art was mainly developed by means of solutions related to perfumes, materials, shapes, colors and ornaments integration while performing the candle manufacture.

On the other hand, placement of flat decorative components on surface of candles already manufactured has seen little development, originating, until today, relatively low quality products compared to candles having integrated decoration while performing the manufacture thereof. Reasons for this failure relates to difficult integration of decoration components on finished candles or, when such integration exists, results in candles visually poor and with defective finish.

Stickers and other replications are opaque and stand out visually from the actual candle, covering it, giving rise to poor qualitative results. For other type of decals there are no stable attachment solutions presenting quality finishing and integration easiness in industrial processes.

Generally, such decorative components, such as stickers, decals and other, are bonded with glues, lacquers and paraffin wax as well. However, the way as paraffin wax is used, both industrially and home handcrafted, does not provide enough transparency to be used as coverage for a thinner image reproduction, this being the reason it is not used for this purpose.

One of the present and more conventional processes of candle manufacture consists in dipping a wick into liquefied paraffin wax with a temperature not exceeding 74° C., providing successive dips but with cooling intervals between dips. For each dip, paraffin wax layer thickness is about 1 mm or more. Such thickness makes the paraffin wax translucent/whitened, and, for that reason, uninteresting as a coverage.

Below, some patent documents allowing the illustration of the closest present state of the art of the present invention are described.

U.S. Pat. No 329,488 issued to Paul A. Lindahl entitled “Process for Decorating Candles and the like” reveals a decoration application process based in melting (moulding) essentially aiming at an embossed decoration design. Such a process is widely used but does not resort to attachment lining.

U.S. Pat. No. 3,867,173 issued to Lenox Candles Inc., entitled “Process of Decorating Objects with Wax”, reveals a candle decoration process based in dipping the candle into a molten film of wax of several colors to create decorative color effects. Here, also, wax is not used to attach and cover decorative components previously placed on the candle.

Korean patent application KR 20020026965 to Jo Jung Suk entitled “Process for Producing Decorative Candle” reveals a decoration process using a molding process in decorated candle production. Here, the entire candle is produced by injecting liquid paraffin into a cast containing decorative patterns. The integrated manufacture of candles is not covered by the present invention.

Chinese patent application CN 1715386, to Xuanle Li entitled “Process for Producing Foamed Candle and Products” reveals a process including molding initial steps followed by a lining application by means of a paraffin layer and a final application with a decorative layer. Here, there are candle lining application steps with very distinctive purposes compared to the present invention.

According to the foregoing, there is a need of a simple process allowing decorating candles in a versatile way and producing magnificent aesthetic results without resorting to integrated decoration processes while performing candle manufacture and being further allowed to be industrially implemented.

### SUMMARY OF THE INVENTION

The present invention discloses a candle comprising:
a body surrounding a wick, which body defines an outer surface comprising at least,
   one base, and
   one top through which a part of said wick projects outwards,
decorative patterns arranged on said outer surface, characterized in that further comprises at least a transparent outer lining of petroleum wax covering said body.

In one aspect of the invention, said petroleum wax is selected from the group consisting of paraffin wax, microcrystalline wax and mixture thereof.

In other aspect of the invention, the outer lining is formed with at least two petroleum wax layers.

In another aspect of the invention, said lining has a thickness equal or lower than about 0.80 mm.

In still another aspect of the invention, the lining has a thickness in the range of about 0.25 to 0.55 mm.

In another aspect of the invention, the lining has a thickness in the range of about 0.30 to 0.40 mm.

In yet another aspect of the invention, the lining comprises additives selected from the group consisting of dyes, flavorings, UV barriers, vegetable waxes, animal waxes, mineral waxes and synthetic waxes.

In another aspect, the candle comprises a transparent lining with a total thickness in the range of about 0.30 to 0.40 mm, which transparent lining is formed with two paraffin wax layers having a UV barrier additive.

The present invention further discloses a candle decoration process which comprises a body surrounding a wick, which body defines an outer surface comprising at least one base and one top through which a part of said wick projects outwards, characterized in that comprises the steps of:
a) application of decorative patterns on the candle outer surface, and
b) application of lining on the candle body by means of dipping it into a liquefied petroleum wax to obtain a lining of at least a transparent and decorative pattern barrier wax layer,
wherein
said dipping is performed by means of a vertical substantially uniform reciprocated movement, to dip the candle in a substantially vertical position, from its base to the top and then remove the candle from the bath, each said reciprocated movement defining the application of a layer on the candle body;
wax temperature is higher than around 80° C.;
the lining application produces a lining with a thickness equal or lower than about 0.80 mm.

In one aspect of the invention, the process comprises a drying step to remove water and/or moisture before the lining application step on the candle body.

In other aspect, the process of the invention comprises a lacquer lining application step after the lining application step on the candle body.

In another aspect, in the decorative pattern application step, decals and paintings and/or printings, thin thickness adhesive materials or combinations thereof are applied.

In still another aspect of the invention, decals are transparent and detachable with water.

In another aspect, in the lining application step, a lining of two or three petroleum wax layers is obtained.

In yet another aspect, the petroleum wax temperature is in a range of around 88° C. to 95° C.

In another aspect of the invention, in the lining application step, a lining with a thickness in a range of 0.25 mm to 0.55 mm is obtained.

In still another aspect of the invention, in the lining application step, a lining with a thickness in a range of 0.30 mm to 0.40 mm is obtained.

In another aspect of the invention, said petroleum wax comprises additives.

In still another aspect, said additives are selected from group consisting of dyes, flavorings, UV barriers, vegetable waxes, animal waxes, mineral waxes and synthetic waxes.

In another aspect, said petroleum wax is selected from the group consisting of paraffin wax, microcrystalline wax and mixture thereof.

### BRIEF DESCRIPTION OF DRAWINGS

Hereinafter the detailed description of the invention is described with reference to the accompanying drawings, in which:

FIG. 1 shows schematically a step of the process of the present invention, in which decorative patterns are applied on a body of a candle;

FIG. 2 shows schematically the candle of FIG. 1 having the decorative pattern;

FIG. 3 shows schematically the beginning of the lining application step of the present invention, of the decorated candle of FIG. 1 e 2;

FIG. 4 shows schematically the dipping down movement of the candle into liquefied wax;

FIG. 5 shows schematically the candle totally dipped into liquefied wax, from which position the up movement to remove the candle from the liquefied wax occurs.

### DETAILED DESCRIPTION OF THE INVENTION

In the following detailed description the term “petroleum wax” or simply “wax” means wax selected from the group comprising paraffin wax, microcrystalline wax and mixture thereof.

To a better understanding of the invention it should be noted that paraffin waxes and microcrystalline waxes can be generally defined as mixtures of saturated long chain hydrocarbons of approximately C₂₀ to C₆₀ (in the case of microcrystalline, approximately, C₃₅ to C₆₀), extremely stable. The paraffin wax melting point is usually comprised between about 47 to 70° C., the microcrystalline wax melting point being comprised between about 54 to 95° C. Usually, microcrystalline waxes are denser, harder and more flexible than paraffin waxes.

The term “decorative patterns” means any components that could be applied on an outer surface of a candle with decorative purposes. As an example, such components could be decal components, stickers, paints or any other provided that its thickness is small compared to the candle global thickness or, in other words, to the candle cross section dimensions.

The term “vertical substantially uniform reciprocated movement” mentioned below means a movement that is being done in a substantially vertical direction and reciprocated with a substantially constant rate. More specifically, the reciprocation is carried out between the down direction and up direction. Such vertical substantially uniform reciprocated movement is done to dip and withdraw a candle from a liquefied wax bath in order to provide a lining on the candle by said wax. Each vertical substantially uniform reciprocated movement provides the formation of one wax layer on the candle to be covered.

The term “plunging time” means the time period that a vertical substantially uniform reciprocated movement takes.

The term “dipping time” means the time period that the candle takes inside the wax bath.

The term “additives” means any components that could be mixed into wax in order to provide the final lining with additional characteristics, such as, for instance, flavoring, UV barrier, coloring, etc. It should be noted that only components that do not compromise the transparency, hence, visibility, of said lining are to be considered.

The present invention discloses a candle comprising a body surrounding a wick, which body defines an outer surface. Said outer surface comprises one base or lower end of the candle which serves to place the candle on a stand or on another location on which it will be able to sit. The outer surface further comprises one top or upper end, through which a part of said wick projects outwards.

The candle of the present invention also comprises decorative patterns arranged on its body outer surface that, on the other hand, are totally lined with a transparent outer lining of petroleum wax, the lining simultaneously providing visual access and protection to said decorative patterns but without damaging them.

The thus formed candle of the invention provides an aesthetic effect simulating a decorated porcelain candle.

Said candle outer lining of the invention is formed with at least one wax layer, wherein, to keep transparency/visibility at adequate levels, it should not exceed 4 wax layers.

In order to provide the unique aesthetic effect, said lining should not have a thickness above 0.80 mm, preferably it will have a thickness in the range of about 0.25 to 0.55 mm and more preferably it will have a thickness in the range of about 0.30 to 0.40 mm.

Wax lining will be able to further include additives, wherein said additives are selected from the group comprising dyes, flavorings, UV barriers, vegetable waxes, animal waxes, mineral waxes, synthetic waxes and similar and combinations thereof.

To a better understanding some examples of vegetable, animals, minerals and synthetics waxes are referred herein below.

Vegetable waxes include but they are not limited to carnauba and candelilla.

Animal waxes include but they are not limited to Chinese wax, spermaceti, beeswax and lanolin.

Mineral waxes include but they are not limited to ceresin and montan wax.

Synthetic waxes include but they are not limited to polyethylene waxes and polyethylene glycol waxes.

The candle of the present invention will be optionally able to further comprise a final lining of candle lacquer provided that its application does not compromise visibility and visual effects of decorative patterns.

A preferred candle of the present invention comprises a transparent lining formed with two paraffin wax layers with a global thickness in the range of 0.30 to 0.40 mm and with a UV barrier additive.

The present invention further discloses a candle decoration process which due to its unique aesthetic characteristics allows simulating the decoration of porcelain candles.

By exploring petroleum wax characteristics and associating them with printing materials such as, for instance, decals detachable with water, a candle having a lining allowing attachment of decorative patterns without damaging them and, on the other hand, having transparency characteristics providing a high quality visual effect, similar to porcelain, was developed. To that effect, a new attachment, protection and finishing process of flat decorative components on the candle surface is described, which process is applicable to other elements in addition to transparent decals.

Surprisingly, it has been shown that under certain conditions it would be possible to apply a wax lining onto decorative components pre-applied on candles without damaging them.

More surprisingly yet is the fact that such lining provides a aesthetic effect never seen before in the state of the art, of the kind that is seen in porcelain items, and that could be easily produced. Such effect is totally unexpected to a person skilled in the art, given all the problems associated with the application of wax layers onto decorative patterns, already mentioned earlier.

In an early development stage of the present invention, the object of the lining was to strengthen attachment of transparent decals to the candle surface and protect them against contact, so that they do not be damaged.

However, following the process development, it has been found that it would be possible to obtain an integration quality of the decals into the candle much beyond the expectations.

It has also been found that the process of the invention is able to be extended to protection and attachment of low thickness components on candle surface or inclusively on painted or printed candles.

Thus, the process of the invention comprises selecting decorative patterns to place on the candle surface that could be, amongst other, transparent decals, and within these, for instance, decals detachable with water. Painting components or others able to be glued on the candle can also be used provide its thickness is considerably thinner than the cross section thickness of the candle to be decorated.

Decals detachable with water are preferred because they are easy to apply than dry decals. They allow a high quality printing copy and since the background is transparent, it is not visible after the wax lining is applied under adequate conditions, resulting in an effect similar to decorated porcelain. Dry decals usually damage the candle surface when they are applied because they do not adhere to the same.

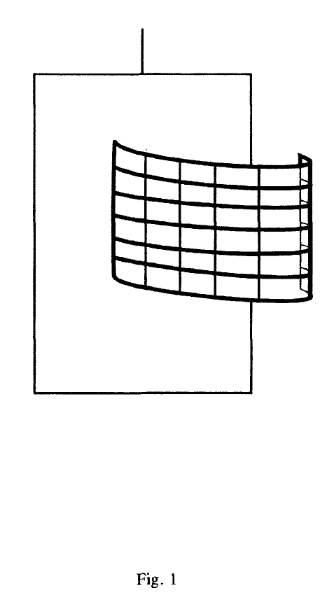

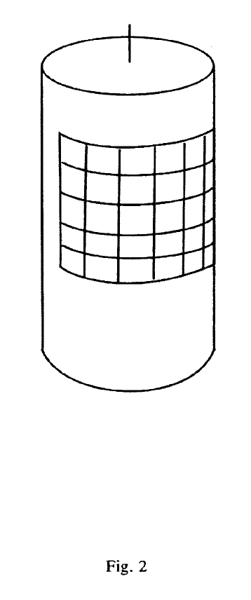

Thus, with reference to FIGS. 1 and 2, in a first step of the process, the decorative patterns are applied on the candle outer surface. Decorative patterns can totally or partially cover said candle outer surface.

When transparent decals are used, they allow a high quality printing copy and they use the actual candle as background. However, transparent decals detachable with water adhere moderately to the candle surface since they are wet, its attachment being sometimes precarious.

Several types of images can be used as printings in the decal, for instance, pictures or graphics/drawings. Images can be previously treated using specialized image software. Printing is performed with known printing processes.

After applying the decals, namely those detachable with water, on the candle surface, if bubbles are formed between decorative patterns and the candle, these bubbles must be removed. Regardless of the need of removing bubbles, there is a need of a full drying of the candle in order to remove water and/or moisture from its surface.

When decorative patterns are dry-applied, the drying step is obviously unnecessary.

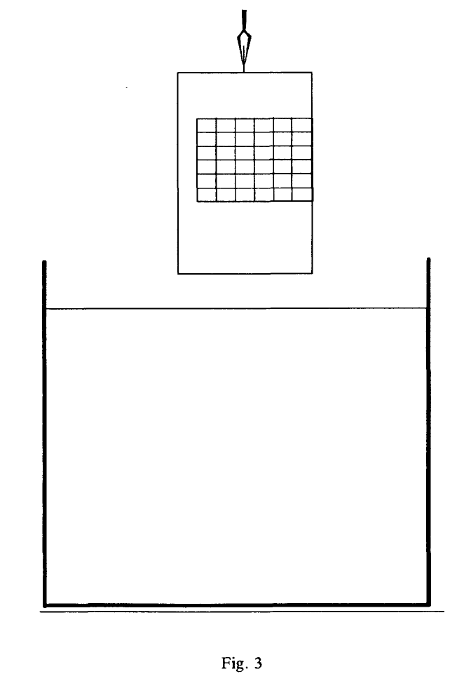

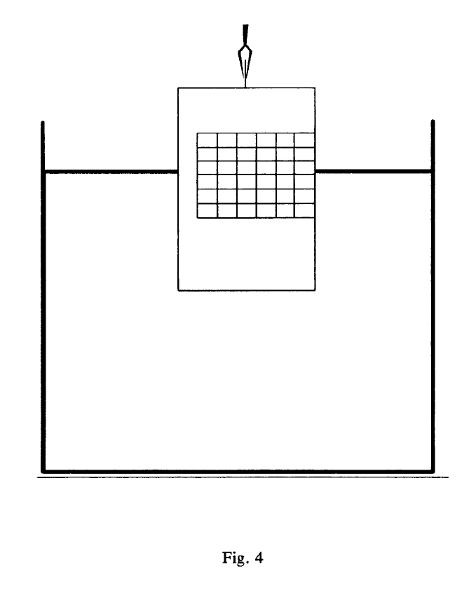

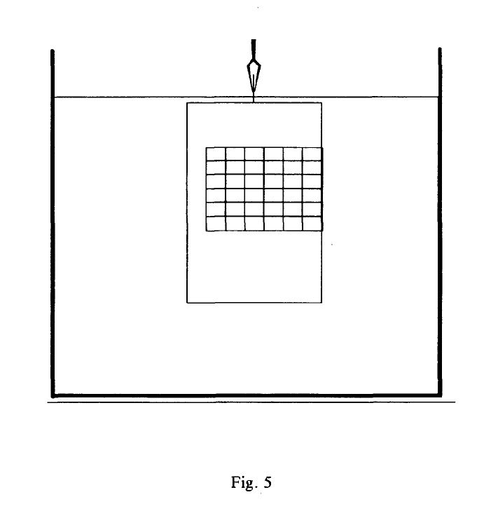

Next, with reference to FIGS. 3, 4 and 5, with a very dry candle, one begins to apply lining to the candle body by means of a warm wax bath (described further in detail later) to obtain a transparent and protective lining of the decorative pattern in the candle and simultaneously to attach the decorative pattern to the candle surface.

After the lining application step, the decorative pattern image appears without quality loss. However, the decal edges are sometimes visible because decals, when they are not properly dry, form visible air capsule or bubbles.

There is also a need to remove any protrusions caused by the decal and visually remove the outlines thereof, although they are transparent, and make the candle surface more smooth and homogeneous.

To that effect, it should be noted that said lining application step is performed by means of a liquefied wax dipping that, on other hand, is made by a vertical substantially uniform reciprocated movement in order to dip the candle in a substantially vertical position from its base to the top and then withdraw the candle from the liquefied wax. Each said reciprocated movement defines the application of a layer on the candle body. Each repetition of such a substantially uniform reciprocated movement provides the addition of a new wax layer to the lining, whereby to obtain, for instance, three wax layers, there is a need to perform three substantially uniform reciprocated movements (i.e., the candle is dipped and removed from the bath three times in a reciprocate way).

Although under certain conditions there can be an interval (of cooling) between dips, these should preferably be sequential or they have to be performed at very short intervals between each other.

To remove said imperfections, additional wax dips are needed, under very particular conditions that will be described further later. The object of this process stage is to prevent that images lose their visual quality.

It should be noted that if a small reduction on visual quality can be seen, this can be compensated by previously processing the image increasing contrast and color density.

Said lining formed by dipping into a liquefied wax bath does not cause decal changes, being said dipping fast, slow or repeated with or without intervals between dips. However, visibility will deteriorate for slow dips and/or with intervals between each other.

After carrying out several tests the conclusion was that to obtain a barrier lining that simultaneously attaches the decal on the candle, does not allow direct contact with the decal, and does not impairs image display, it is enough to perform a single dip. Such a dip must be performed at a temperature above approximately 80° C., giving rise to a 0.35 mm to 0.45 mm lining, although under these conditions the decal edges are visible, as well as small projections and surface imperfections.

To eliminate the display drawbacks of decal edges and small surface imperfections there is a need to perform two or three liquefied wax dips, which makes the lining thicker and smoother, although it could be slightly less transparent.

To achieve an excellent image visual quality having a lining of 2 or more layers, the final thickness of said lining has to be the same or lower than about 0.55 mm, which guarantees the transparency needed.

In order to obtain the best transparency results allowing a good image display printed into the decal, there is a need to perform sequential dips, preferably 2 or 3 dips into liquefied wax at a temperature of around 84° C. or more.

Good results are consistently achieved using a wax bath at a temperature in the range of about 88° C. to 92° C., preferably about 92° C., to obtain lining thicknesses lower than about 0.5 mm, preferably in the range of about 0.30 mm to 0.40 mm. Under these conditions, image quality is maintained, the decal edges and small projections not being noticeable, and assuring a smooth surface.

After lining application according to the present invention, decorative patterns appear fully integrated on the candles, well visible, on a smooth, uniform and shining surface, whereby image is perceived as forming part of the actual candle (such as in porcelain) and not as being glued on the surface. Such results represent a significant evolution compared to the prior art, providing a high quality final product.

There could further be a final, optional step of applying a lining of candle lacquer.

It is also possible to use additives into the liquefied wax without influencing the final result to obtain thicknesses that guarantee the best results. In the tests performed, undesired effects related to additive presence were not noticed, such as, increased opacity, translucence, consistency, texture and homogenization, color fixation and undesired odor.

Still regarding the additives, particularly additives providing solar filtration usually used in candle manufacture, they do not change the achieved results, and they could provide a significant contribution to maintain image colors in the decal over time.

With reference to using dyes in wax baths, more or less intense tones can be obtained according to the amount of dye added or to the number of dips applied. However, the lining transparency is kept, allowing to provide the candle with a tone that could be important for decoration.

The present process is also effective when applied in candles painted directly on the surface thereof, thus providing a high quality finish.

The lining step of the present invention can also be applied in candles having other materials glued provided that the thickness of the same is small and allowing the difference between candle lining thickness and applied components thickness be the same or lower than 0.5 mm.

Next, tests explaining in a detailed way particular conditions of the process of the invention allowing to obtain unique characteristics of a candle thus decorated are described.

TESTS

1—Test of Dry-Decals and Detachable with Water Decals Application

Two kinds of decals were selected, both with a transparent background, that were applied in 2 sets of 10 candles each, it has been found that:
in the dry application process, the decal has adherence related problems on the candle surface, being very difficult to detach itself from its base, and causing marks on the candle surface and imperfections in the actual decal. The lack of bonding results from the fact that the candle is a basic material having more oil content, hence, less adherent than the base of the actual decal.
in the detachment process with water, the decal is easily passed to the candle surface but it has drawbacks since bonding is not so good and requires rinsing and further drying. Water and candle surface are incompatible since the latter is oily.

2—Assessment Test Related to the Formation of the Lining and Decal Performance In Contact with Paraffin, in Candles with a Decal Applied, being Totally Dried or Damped.

In 4 groups of 10 candles each, with decals applied using the detachment process with water, linings with one and two layers were made by dipping into heated paraffin at 92° C., wherein, in one case, candles were well dry and, in another case, they were damp.

A qualitative assessment of the lining quality was made by a group of 3 people skilled in the art. Quality evaluation parameters were classified like: “bad”, “poor”, “acceptable” and “good”.

TABLE 1
Lining quality

| Layers | Dry candle | Damp candle |
|---|---|---|
| 1 layer | good | bad |
| 2 layers | good | bad |

It has been noted that in dry candles the bonding between the lining and the candle surface was absolute, wherein, in damp candles, air capsules appeared from bad bonding between lining and decal and candle surfaces, originating opacities.

The conclusion was that a good bonding between lining and decal and candle surfaces is a consequence of a previous drying that fully removes moisture.

The same group of people skilled in the art mentioned previously was considered for all tests below requiring a qualitative assessment.

3—Tests of Paraffin Wax Linings

Tests which purpose was to assess visual quality of candles after performing lining operations were carried out. The tests have been performed using candles to which identical decals were applied, having the following characteristics:
white candles, 185 mm height, main cylinder of 165 mm, bell-mouth of 20 mm, 67 mm perimeter and 55 g weight,
decals had a height of 141.5 mm and 50 mm width, and were detachable with water,
decal printed image had lines of 2 pt by 141.5 mm, in black, yellow, green, red, having 6 lines by color, with 100%, 50%, 30%, 20%, 10% and with 5% of color.

Liquefied paraffin wax baths heated to 92° C. were used to produce linings.

In the next table, assessed characteristics from tests carried out and described further later are summarized.

| Test | Assessed characteristics |
|---|---|
| A | 1 layer and plunging time variation |
| B | 1 layer and dipping time variation |
| C | 2, 3 and 4 layers and plunging time variation |
| D | several layers and cooling time variation |
| E | dipping fluidity |
| F | groove removal |
| G | intervals between linings |
| H | bath temperature variation |
| I | additive insertion |
| J | UV filter additive |
| L | dye insertion |
| M | painted decorative patterns |
| N | other patterns than decals |
| O | microcrystalline wax linings |

A detailed description of said tests is following done.

Test A: Lining Assessment Having 1 Layer and Different Plunging Times

The lining was provided with 1 paraffin wax layer (only 1 dip) at different rates, without interruption of the dipping movement inside the bath.

The purpose was to assess image visual quality, decal performance and candle surface after lining application. To that effect, linings were applied with different plunging times.

Plunging time (s)

| | | 1.5 | 3 | 6 | 9 |
|---|---|---|---|---|---|
| Lining thickness | Top | 0.25 | 0.4 | 0.35 | 0.3 |
| (mm) | Base | 0.35 | 0.4 | 0.45 | 0.45 |

Comparing visual quality of different bands for color and gradation, significant variations from candle to candle, even in extreme cases when plunging time was 1.5 s and 9 s did not take place.

Comparing lined candles with candles before lining application, significant visibility losses were not seen, decal edges became less evident, although visible, a slight increase of candle perimeter did occur, more pronounced in the base, as expected, and decal didn't suffer any changes with the paraffin bath.

Thus, with a lining layer:
decal visual quality or the decal itself did not change,
in the tested range, plunging time did not have significant influence,
decal edges were visible,
superficial imperfections were noticeable,
lining was effective as protection, did not allow direct contact with decal and attaching it on the candle,
lining thickness was in the range of about 0.25 m to 0.45 mm.

Test B: Lining Assessment Having 1 Layer and Different Plunging Times

The lining was provided with 1 paraffin wax layer (only 1 dip) emerging and dipping candles at the same rate but interrupting the dipping movement inside the bath, that is, with dipping time.

The purpose was to assess image visual quality, decal performance and candle surface after lining application. In this case, there is a plunging interruption inside the bath, allowing the candle to be dipped into it. The varying parameter in this test was the candle residing time (or dipping time) into liquefied paraffin wax.

The candles of the previous test were used as reference candles subject to a plunging time of 1.5 seconds. Next table summarizes the results obtained.

| Dipping time (s) | | Reference candles | 2 | 4.5 | 8.5 | 10.5 |
|---|---|---|---|---|---|---|
| Lining thickness | top | 0.25 | 0.55 | 0.38 | 0.40 | 0.43 |
| (mm) | base | 0.34 | 0.62 | 0.60 | 0.55 | 0.58 |

All decal drawing lines were visible.

The longest dips had a slighter loss of visual quality.

Decal edges were almost unnoticeable but surface imperfections were visible. The decal didn't suffer any changes with the liquefied paraffin wax bath.

Comparing between reference candle and before the bath candle, significant changes did not occur, although the lining thickness has somewhat increased, as expected.

Thus, under such conditions:
linings were thicker, and thickness changed from about 0.38 mm to 0.62 mm,
visual quality was maintained,
decal edges were almost unnoticeable,
superficial imperfections did occur.

Test C: Lining Assessment Having 2, 3 and 4 Layers, Different Plunging Times and Cooling Between Dips

Lining operations with 2, 3 and 4 paraffin wax layers were carried out, with plunging times of 1 s, 5 s, 3 s and 6 s, leaving candles to cool between dips.

The purpose, after the previous test B, was to assess image visual quality, decal performance and candle surface after applying 2, 3 and 4 paraffin wax lining layers. Next table summarizes the results obtained.

| | Plunging time (s) | | | | | | | | |
|---|---|---|---|---|---|---|---|---|---|
| | 1.5 | | | 3 | | | 6 | | |
| No of layers | 2 | 3 | 4 | 2 | 3 | 4 | 2 | 3 | 4 |
| Thickness | | | | | | | | | |
| (mm) | | | | | | | | | |
| Top | 0.5 | 0.9 | 1.5 | 0.6 | 0.9 | 1.2 | 0.4 | 0.7 | 1.1 |
| Base | 0.8 | 1.2 | 1.8 | 0.8 | 1.2 | 1.4 | 0.8 | 0.9 | 1.3 |
| visibility(*) | | | | | | | | | |
| 5% | 2 | 1 | 1 | 2 | 1 | 1 | 2 | 1 | 1 |
| 10% | 2 | 1 | 1 | 2 | 1 | 1 | 2 | 1 | 1 |
| 20% | 2 | 2 | 1 | 2 | 2 | 1 | 2 | 2 | 1 |
| 30% | 4 | 2 | 1 | 4 | 2 | 2 | 4 | 2 | 1 |
| 50% | 4 | 2 | 1 | 4 | 3 | 2 | 4 | 3 | 1 |
| 100% | 4 | 3 | 1 | 4 | 3 | 2 | 4 | 3 | 2 |
| Rating | 18 | 11 | 6 | 18 | 12 | 9 | 18 | 12 | 7 |

(*)1—without visibility, 2—bad, 3—insufficient, 4—sufficient, 5—good. Assessment made by the group of people skilled in the art.

It has been seen that decal edges are no longer visible and that candle surface is smooth and uniform. Candles having two lining layers displayed a better visual quality, wherein lining thickness having two layers is in the range of 0.4 mm to 0.8 mm. Decal did not suffer any changes with the liquefied paraffin wax bath.

Thus:
2 layers linings obtained the best result, regardless of the plunging time,
Comparing with reference candle, a slight loss of transparency occur,
Surface was smoother and uniform, and decal edges were unnoticeable,
Decal did not seem to be placed on the candle surface, as in the reference candle, but instead integral with the same.

Test D: Lining Assessment Having Several Layers, and Different Cooling

Linings with 2 and 3 paraffin layers were performed, with plunging times of 1.5 s and different cooling times between dips.

The purpose, after the previous test C, was to assess image visual quality, decal performance and candle surface after applying 2 or 3 lining layers under different circumstances, namely:

a) cooling between each dip,

b) a short interval causing a slight cooling between dips,

c) without interval/cooling.

Next table summarizes the results obtained.

| | No of layers | | | | | |
|---|---|---|---|---|---|---|
| | 2 layers | | | 3 layers | | |
| Cooling | yes | short | no | yes | short | no |
| Thickness(mm) | | | | | | |
| Top | 0.55 | 0.60 | 0.30 | 1.00 | 1.00 | 0.45 |
| Base | 0.80 | 0.75 | 0.45 | 1.05 | 1.05 | 0.60 |
| visibility | | | | | | |
| 5% | 1 | 1 | 1 | 1 | 1 | 1 |
| 10% | 2 | 2 | 3 | 1 | 1 | 3 |
| 20% | 2 | 3 | 3 | 2 | 2 | 3 |
| 30% | 3 | 3 | 4 | 2 | 2 | 4 |
| 50% | 3 | 3 | 4 | 2 | 2 | 4 |
| 100% | 3 | 4 | 5 | 2 | 2 | 5 |
| Rating | 14 | 16 | 20 | 10 | 10 | 20 |

It has been seen that linings having 2 or 3 layers, without interval between dips, display the best visual results, followed by 2 lining layers with a short interval. Linings having 3 layers obtained with an interval displayed a poor visual quality.

Linings thicknesses having 2 or 3 layers without interval between dips had about 0.3 mm to 0.45 mm and about 0.45 mm to 0.6 m respectively. Comparing to the reference candle, the visual loss was not significant, and the surface obtained was smoother and uniform and the decal edges were unnoticeable.

Cooling between dips caused the formation of a thicker lining with transparency loss.

Decal did not suffer any changes with the liquefied paraffin wax bath.

Thus, linings formed with 2 layers without cooling or with a short cooling and with 3 layers without cooling, provided a good visual quality and a smoother and more homogeneous surface compared to the reference candle.

Test E: Assessment of Dipping Fluidity

The purpose was to assess image visual quality, decal performance and candle surface after irregular and stirred dips.

Dips having discontinuous and irregular movements were carried out, at different rates, and with intervals between dips and at different bath temperatures.

It has been seen that the candle surface has became irregular, with waves, caused by such movements that are more pronounced the bigger the paraffin wax viscosity and lower the bath temperature.

The conclusion was that to obtain a uniform surface the dips into paraffin should be carried out with a uniform movement without interruptions, into a low viscosity paraffin wax at a high temperature.

Test F: Assessment of Groove Removal

To assess groove removal, 2 marks deep enough were made on the side surface of each candle, close to top and base. The purpose was to assess how the bath covers and/or removes such marks. To that effect, a number of dips were carried out, such as pointed out next:

1 quick dip,

2 sequential quick dips

2 quick dips with a short interval, and

3 sequential quick dips

It has been seen that a single dip was not enough to cover or fill the marks. Two sequential quick dips have improved but were not enough to cover or fill the marks. Two quick dips but with a short interval or 3 dips smoothen the surface filling up the marks.

Accordingly, two or three dips enable smoothing the surface.

Test G: Assessment of Intervals Between Linings

The purpose, after the previous tests D and F, was to assess image visual quality, decal performance and candle surface after applying 2 or 3 lining layers with intervals not allowing cooling, which are defined below as shorts, very shorts and without interval.

Next Table exhibits the results obtained.

| | No of layers | | | | | |
|---|---|---|---|---|---|---|
| | 2 layers | | | 3 layers | | |
| Interval | short | very short | no | short | very short | no |
| Thickness(mm) | | | | | | |
| Top | 0.50 | 0.35 | 0.30 | 0.60 | 0.60 | 0.55 |
| Base | 0.75 | 0.55 | 0.40 | 0.80 | 0.65 | 0.65 |
| visibility | | | | | | |
| 5% | 2 | 2 | 2 | 1 | 1 | 2 |
| 10% | 2 | 2 | 3 | 1 | 1 | 2 |
| 20% | 2 | 3 | 4 | 2 | 2 | 3 |
| 30% | 3 | 3 | 4 | 2 | 2 | 3 |
| 50% | 3 | 3 | 4 | 2 | 2 | 4 |
| 100% | 3 | 4 | 4 | 2 | 2 | 4 |
| Rating | 15 | 17 | 21 | 10 | 10 | 18 |

It has been seen that visual quality was better in a 2 layer lining without interval, followed by the 3 layer lining also without interval, followed by the 2 layer lining with a very short interval. When interval between dips increases, visual quality became poorer, this being the case of 3 layer linings and short interval or even very short.

It was possible to see that lining thickness was very thin, from about 0.3 mm to 0.4 m for 2 layers without time interval between dips, from about 0.35 mm to 0.55 mm for 2 layers with very short interval and from about 0.55 mm to 0.65 mm for 3 layers without interval.

Decal edges were unnoticeable and surface was smooth.

Decal didn't suffer any changes.

Thus, it is clear that 2 or 3 continuous dips or 2 dips with a very short interval were good quality solutions for the lining, both to maintain visual quality compared to the reference candle and by making decal edges and small protuberances and surface imperfections unnoticeable.

Test H: Assessment of Linings Having Several Layers and Different Cooling in baths at different temperature.

The purpose was to assess thickness and visual quality related to a paraffin viscosity variation of the bath caused by its temperature variation.

After the previous test G, linings exhibiting best quality were repeated, by varying, in this case, bath temperature.

Test results are described in the next tables which are organized by temperature and by number of layers.

It should be noted that visual quality assessment was carried out by the same group of people skilled in the art, and also varied from 1 to 5, like this: 1—without visibility, 2—bad, 3—insufficient, 4—sufficient, 5—good. Linings referred as 1+1 were obtained by means of two dips with a very short interval (virtually without cooling) between the first and the second bath.

Table of visual quality assessment - Temperature variation

| | Temp. (° C.) Paraffin Wax | | | | | | | | |
|---|---|---|---|---|---|---|---|---|---|
| | 74 | | | | 80 | | | | |
| No of layers | 1 | 1 + 1 | 2 | 3 | 1 | 1 + 1 | 2 | 3 | 4 |
| Thickness (mm) | | | | | | | | | |
| Top | 0.45 | 0.85 | 0.70 | 0.65 | 0.35 | 0.70 | 0.42 | 0.52 | 0.65 |
| Base | 0.52 | 0.95 | 0.65 | 0.80 | 0.45 | 0.85 | 0.60 | 0.67 | 0.75 |
| Ass. Visual Qual. | 1 | 1 | 1 | 1 | 5 | 3 | 4 | 4 | 4 |

| | Temp. (° C.) Paraffin Wax | | | | | | | | |
|---|---|---|---|---|---|---|---|---|---|
| | 84 | | | | 88 | | | | |
| No of layers | 1 | 1 + 1 | 2 | 3 | 1 | 1 + 1 | 2 | 3 | 4 |
| Thickness (mm) | | | | | | | | | |
| Top | 0.35 | 0.60 | 0.40 | 0.55 | 0.40 | 0.45 | 0.37 | 0.45 | 0.65 |
| Base | 0.50 | 0.75 | 0.55 | 0.63 | 0.45 | 0.68 | 0.55 | 0.50 | 0.45 |
| Ass. Visual Qual. | 5 | 3 | 5 | 4 | 5 | 3 | 5 | 5 | 3 |

| | Temp. (° C.) Paraffin Wax | | | |
|---|---|---|---|---|
| | 92 | | | |
| No of layers | 1 | 1 + 1 | 2 | 3 |
| Thickness (mm) | | | | |
| top | 0.35 | 0.30 | 0.35 | 0.33 |
| base | 0.35 | 0.50 | 0.45 | 0.40 |
| Ass. Visual Qual. | 5 | 3 | 5 | 5 |

Table of visual quality assessment - Layer number variation

| | No of layers | | | | | | | | | |
|---|---|---|---|---|---|---|---|---|---|---|
| | 1 | | | | | 1 + 1 | | | | |
| | Temp. (° C.) Paraffin wax | | | | | | | | | |
| | 74 | 80 | 84 | 88 | 92 | 74 | 80 | 84 | 88 | 92 |
| Thickness (mm) | | | | | | | | | | |
| top | 0.45 | 0.35 | 0.35 | 0.40 | 0.35 | 0.85 | 0.70 | 0.60 | 0.45 | 0.30 |
| base | 0.52 | 0.45 | 0.50 | 0.45 | 0.35 | 0.95 | 0.85 | 0.75 | 0.68 | 0.50 |
| Ass. Visual Qual. | 3 | 5 | 5 | 5 | 5 | 1 | 2 | 3 | 3 | 3 |
| | No of layers | | | | | | | | | |
| | 2 | | | | | 3 | | | | |
| | Temp. (° C.) Paraffin wax | | | | | | | | | |
| | 74 | 80 | 84 | 88 | 92 | 74 | 80 | 84 | 88 | 92 |
| Thickness (mm) | | | | | | | | | | |
| Top | 0.70 | 0.42 | 0.40 | 0.37 | 0.35 | 0.65 | 0.52 | 0.55 | 0.45 | 0.33 |
| Base | 0.65 | 0.60 | 0.55 | 0.55 | 0.45 | 0.80 | 0.67 | 0.63 | 0.50 | 0.40 |
| Ass. Visual Qual. | 1 | 4 | 4 | 5 | 5 | 1 | 3 | 3 | 5 | 5 |

| | No of layers | | | | | | |
|---|---|---|---|---|---|---|---|
| | 4 | | | | | 5 | |
| | Temp. (° C.) Paraffin wax | | | | | | |
| | 74 | 80 | 84 | 88 | 92 | 88 | 92 |
| Thickness (mm) | | | | | | | |
| top | — | 0.65 | 0.55 | 0.65 | 0.40 | 0.50 | 0.55 |
| base | — | 0.75 | 0.70 | 0.45 | 0.50 | 0.50 | 0.60 |
| Ass. Visual Qual. | 1 | 3 | 3 | 4 | 4 | 4 | 4 |

According to the results, it has been seen that:
around 74° C., visual quality was bad
above 84° C., visual quality was generally good,
between 88° C. and 92° C., visual quality was consistently good,
dips with an interval (very short) 1+1, between 74° C. and 84° C., were insufficient or had a bad visual quality,
linings having one or more than one layer and a thickness lower than 0.5 mm had a good visual quality,
linings having several layers made a smoother and more uniform surface and provided a perception of a better integration of the image on the candle,
in linings having several layers, decal edge was unnoticeable,
there were no additional gains in the candle visual quality with more than three dips,
decals did not suffer any changes.

The conclusion was that bath temperature influenced decisively the lining formation.

Lining crystallization and formation varies according to paraffin wax viscosity of the bath which varies conversely with temperature.

By means of bath temperature, number of layers and interval existence (or not) between dips it was possible to obtain, in a controlled way, paraffin wax linings very thin and having a high transparency grade allowing a good display of the printed image in the decal. Decal didn't suffer any changes neither with the dips nor with the temperatures.

Test I: Assessment of Linings 1+1, 2, 3 in Paraffin Wax Baths with Different Additive Mixtures

The purpose was to assess thickness and visual quality that additives could provide to linings, compared to the test of paraffin wax without mixtures.

To that effect, baths of liquefied paraffin wax with additives usually used in candle production at a temperature of 88° C. were performed.

It was not possible to see significant changes, both in visual quality and thicknesses obtained, compared to tests without additives.

Thus, the conclusion is that additives did not influence the final result.

Test J: Assessment of Linings 1+1, 2, 3 with UV

Tests with a mixture of liquefied paraffin wax and one additive were carried out for the purpose of blocking UV radiation, which did not change the image visual quality.

Using such type of solar filters is important in a context of protection of the colors from the decal image.

Test L: Assessment of Linings 1+1, 2, 3 with Dyes

Tests were made by adding dyes into the liquefied paraffin wax, wherein tones more or less intense were obtained according to the added amount of dye or to the number of dips applied.

It has been seen that transparency was maintained.

Test M: Assessment of Lining in Candles Whose Surface was Painted and/or Printed Using Paints of Several Colors

White test candle surfaces were directly painted and/or printed with several colors.

The results for 2 and 3 dips of liquefied paraffin wax are described in the table below.

| | Number of dips | | |
|---|---|---|---|
| | 2 dips | 3 dips | |
| Cooling Interval | No interval | No interval | With interval |
| Lining thickness (mm) | 0.55 | 0.78 | 1.27 |
| Painting resolution | very good | good | bad |
| Superficial finishing | good | very good | bad |

It has been seen that good results were achieved using 2 and 3 dips without interval.

The conclusion was that lining is equally effective when applied directly on the surface of painted/printed candles providing a high quality finish.

Test N: Assessment of Other Flat Materials Having a Number of Thicknesses on the Candle Surface

Instead of decals, printed papers having the same graphics than the decals were glued on the candles.

It has been seen that lining worked equally well in such cases, wherein a uniform surface on well glued surfaces and having low paper thicknesses were obtained.

The conclusion was that such a lining process could be applied in candles having other materials glued provided the difference between candle lining thickness and said material thickness is the same or lower than 0.5 mm.

Test O: Assessment of 100% Microcrystalline Wax Linings and Mixtures of Microcrystalline Waxes and Paraffin Wax Having Several Layers and in Baths at different temperatures

100% microcrystalline wax linings and linings of a mixture of microcrystalline wax and paraffin wax were assessed compared to linings obtained from a single paraffin wax, wherein tests of linings having 1, 2 and 3 layers at temperatures of about 74° C., 84° C. and 92° C. were carried out.

It has been seen that linings having 1 layer, at 84° C. and 92° C., exhibit visual results similar to the paraffin wax lining, however, the lighting reflection on the surface became slightly dimmer, being also different to the touch.

Is has further been seen that in linings having 2 and 3 layers, at 84° C., image visual quality was poorer, the lining loosing transparency. At 92° C., linings exhibited similar visual results to the paraffin wax lining however, such as at 84° C., the lighting reflection on the surface became dimmer, being also different to the touch.

The conclusion was that 100% microcrystalline wax lining or linings of mixtures of microcrystalline wax and paraffin wax produced linings visually similar to those of paraffin wax, having a lighting reflection on the surface slightly poorer, and a different touch.

1. A candle comprising
a body surrounding a wick, which body defines an outer surface comprising at least,
one base, and
one top through which a part of said wick projects outwards,
decorative patterns arranged on said outer surface,
characterized in that further comprises at least a transparent outer lining of petroleum wax having a thickness in the range of about 0.25 mm to 0.55 mm covering said body.

2. The candle according to claim 1, wherein said petroleum wax is selected from the group consisting of paraffin wax, microcrystalline wax and mixtures thereof.

3. The candle according to claim 1, wherein the outer lining is formed with at least two petroleum wax layers.

4-20. (canceled)

21. The candle according to claim 1, wherein the lining has a thickness in the range of about 0.30 to 0.40 mm.

22. The candle according to claim 1, wherein the lining comprises additives selected from the group consisting of dyes, flavourings, UV barriers, vegetable waxes, animal waxes, mineral waxes and synthetic waxes.

23. The candle according to claim 1, comprising a transparent lining having a total thickness in the range of about 0.30 to 0.40 mm, which transparent lining is formed with two paraffin wax layers having a UV barrier additive.

24. A candle decoration process which comprises a body surrounding a wick, which body defines an outer surface comprising at least one base and one top through which a part of said wick projects outwards,
characterized in that comprises the steps of:
a) application of decorative patterns on the candle outer surface, and
b) application of lining on the candle body by means of dipping into a liquefied petroleum wax to obtain a lining of at least one transparent and decorative pattern barrier wax layer,
wherein
said dipping is performed by means of a vertical substantially uniform reciprocated movement, to dip the candle in a substantially vertical position, from its base to the top and then remove the candle from the bath, each said reciprocated movement defining the application of one layer on the candle body;
wax temperature is higher than around 80° C.;
the lining application produces a lining with a thickness in the range of about 0.25 mm to 0.55 mm.

25. The process according to claim 24, comprising a drying step to remove water and/or moisture before the lining application step on the candle body.

26. The process according to claim 24, comprising a lacquer lining application step after the lining application step on the candle body.

27. The process according to claim 24, wherein, in the decorative pattern application step, decals, and paintings and/or printings, thin thickness adhesive materials or combinations thereof are applied.

28. The process according to claim 27, wherein said decals are transparent and detachable with water.

29. The process according to claim 24, wherein, in the lining application step, a lining of two or three petroleum wax layers is obtained.

30. The process according to claim 24, wherein the petroleum wax temperature is in a range of about 88° C. to 95° C.

31. The process according to claim 24, wherein, in the lining application step, a lining with a thickness in a range of 0.30 mm to 0.40 mm is obtained.

32. The process according to claim 24, wherein said petroleum wax comprises additives.

33. The process according to claim 32, wherein said additives are selected from group consisting of dyes, flavourings, UV barriers, vegetable waxes, animal waxes, mineral waxes and synthetic waxes.

34. The process according to claim 24, characterized in that said petroleum wax is selected from the group consisting of paraffin wax, microcrystalline wax and mixture thereof.
